(19) United States
(12) Patent Application Publication
(10) Pub. No.: US 2025/0338259 A1
(43) Pub. Date: Oct. 30, 2025

(54) ADAPTIVE FREQUENCY MANAGEMENT FOR TRANSMISSIONS

(71) Applicant: TEXAS INSTRUMENTS INCORPORATED, Dallas, TX (US)

(72) Inventors: Yaron Alpert, Hod Hasharon (IL); Barak Cherches, Ramat-Hakovesh (IL); Yoav Ben-Yehezkel, Netanya (IL); Yossi Bouskila, Ramat-Gan (IL); Tal Cohen Shechter, Beer-Sheva (IL); Eliav Herman, Haifa (IL)

(21) Appl. No.: 18/649,432

(22) Filed: Apr. 29, 2024

(51) Int. Cl. H04W 72/0446

(52) U.S. Cl. CPC H04W 72/0446

(57) ABSTRACT

In an embodiment, a method includes determining a first upcoming transmission from a device in a first communication channel during a first time window and determining a first aggregate parameter associated with transmissions of the device in the first communication channel during the first time window. In response to determining that the first aggregate parameter does not exceed the threshold parameter level, the method includes transmitting the first upcoming transmission in the first communication channel during the first time window without listening to the first communication channel.

### TECHNICAL FIELD

The present disclosure relates generally to communication systems and methods, and in particular embodiments, to a method for adapting frequencies of transmissions.

### BACKGROUND

In wireless communication environments, radio frequency devices can communicate with other devices using one or more frequencies within frequency bands and by using one of several wireless communication protocols (e.g., Bluetooth). Radio frequency bands may include licensed bands and unlicensed bands. Licensed bands may require a device, or user thereof, to obtain a license (e.g., from a, e.g., government agency of a country or group of countries) to operate within a certain wireless spectrum to reduce interference with transmissions. Users may transmit communications in unlicensed bands without paying fees or obtaining a license from a local regulator.

License Assisted Access (LAA) is a wireless communication feature offered that leverages both unlicensed bands in combination with licensed bands to enable performance boosts in various radio frequency devices. However, devices operating with LAA may still be subject to various regulations to enable fair coexistence (e.g., frequency bands sharing) with other technologies using the same, e.g., unlicensed bands and to avoid interfering with each other. More specifically, such regulations may limit the size or duration of transmissions within a communication channel of a frequency band regardless of which communication protocol is used for the transmissions (e.g., Bluetooth, BLE, ZigBee, Wi-Fi, LTE, LTE-M, NB-IoT).

Given such regulations, existing solutions employ channel sensing operations prior to accessing a communication channel. One example of a channel sensing operation is called Listen-Before-Talk (LBT), or Listen-Before-Transmit, wherein a radio transmitter first senses the radio environment operating within a frequency band before the transmitter starts a transmission. In this way, LBT is used to verify a communication channel is clear before transmissions occur and potentially interfere with other transmissions. Another example of a channel-sensing operation is called Detect and Avoid (DAA). Devices using DAA techniques also sense other transmissions within a given frequency band and avoid transmitting if the frequency band is busy.

### SUMMARY

Some embodiments disclosed herein advantageously result in improvements to wireless transmissions.

Listen-Before-Talk (LBT) and Detect and Avoid (DAA) techniques may introduce additional operations before transmitting, which may impact the current consumption and power requirements of a device, and may increase the time and overhead for transmission as a device may sense multiple frequencies before each operation (e.g., transmission), which may result in a decrease in battery life of the device.

Some embodiments advantageously avoid performing channel sensing operations, such as LBT and DAA while still complying with one or more regulations or requirements, e.g., to allow for fair wireless coexistence.

In some embodiments, such regulations or requirements may relate to unlicensed frequency bands.

In some embodiments, such regulations or requirements relate to 2.4 GHz frequency band.

In some embodiments, such regulations or requirements have a threshold parameter level associated with aggregate transmission parameter(s) (e.g., amount of data transmitted by a device in a particular frequency, power transmitted by a device in a particular frequency, etc.) for a particular time window. In some embodiments, the aggregation of transmission parameters is performed per frequency.

In some embodiments, transmissions by the device in the particular frequency that do not exceed the threshold parameter level in the particular time window may be performed in the particular time window in the communication channel associated with the threshold parameter level without performing communication channel sensing while still complying with such regulations or requirements.

In some embodiments, such transmissions by the device may be performed in a single stack of a single protocol. In some embodiments, such transmissions by the device may be performed in multiple stacks of a single protocol. In some embodiments, such transmissions by the device may be performed in multiple stacks of multiple protocol.

In some embodiments, an aggregate transmission parameter associated with all transmissions (including one or more pending transmissions) of a device in a particular communication channel in a particular time window is determined. If the aggregate transmission parameter is less than a predetermined threshold level associated with the communication channel, the one or more pending transmissions may be advantageously transmitted by the device in the particular communication channel in the particular time window without performing channel sensing of the communication channel.

In some embodiments, an aggregate transmission parameter associated with all transmissions (including one or more pending transmissions) of a device in a particular communication channel in a particular time window is determined. If the aggregate transmission parameter exceeds a predetermined threshold level associated with the communication channel, the device may delay transmission of one or more of the one or more pending transmissions to a later time window and in the same communication channel, e.g., to advantageously avoid performing channel sensing of the communication channel (e.g., since in the later time window, the associated aggregate parameter may be advantageously lower).

In some embodiments, an aggregate transmission parameter associated with all transmissions (including one or more pending transmissions) of a device in a particular communication channel in a particular time window is determined. If the aggregate transmission parameter exceeds a predetermined threshold level associated with the communication channel, the device may adjust of one or more parameters (e.g., reduce amount of data to be transmitted, reduce amount of power used for the transmissions, etc.) of the one or more pending transmissions to a later time window and in the same communication channel, e.g., to advantageously avoid performing channel sensing of the communication channel (e.g., since in the later time window, the associated aggregate parameter may be advantageously lower).

In some embodiments, an aggregate transmission parameter associated with all transmissions (including one or more pending transmissions) of a device in a particular communication channel in a particular time window is determined. If the aggregate transmission parameter exceeds a predetermined threshold level associated with the communication channel, the device may schedule transmission of one or more of the one or more pending transmissions to a different communication channel, e.g., in the same time window, e.g., to advantageously avoid performing channel sensing of the communication channel (e.g., since, in the other communication channel, the associated aggregate parameter may be advantageously lower). By using another communication channel in the same time window, some embodiments may advantageously avoid performing channel sensing of the communication channel without delaying transmission.

In some embodiments, an aggregate transmission parameter associated with all transmissions (including one or more pending transmissions) of a device in a particular communication channel in a particular time window is determined. If the aggregate transmission parameter exceeds a predetermined threshold level associated with the communication channel, the device may split transmissions of one or more of the one or more pending transmissions to multiple communication channel, e.g., in the same time window, e.g., to advantageously avoid performing channel sensing of communication channel (e.g., since, by splitting transmissions in multiple channels, the associated aggregate parameters associated with each of the multiple channels may be advantageously lower). By using multiple communication channel in the same time window, some embodiments may advantageously avoid performing channel sensing of the communication channels without delaying transmission.

In some embodiments, an aggregate transmission parameter associated with all transmissions (including one or more pending transmissions) of a device in a particular communication channel in a particular time window is determined. If the aggregate transmission parameter exceeds a predetermined threshold level associated with the communication channel, the device may perform limited channel sensing of the communication channel with a duration that is proportional to one or more parameters (e.g., amount of data, amount of power, etc.) of the pending transmissions. By limiting the duration of the channel sensing, some embodiments advantageously improve transmission efficiency (e.g., since the device spends less time listening to the channel while still being able to transmit the pending transmissions).

Some embodiments may adapt frequencies to transmit in frequency band communication channels while advantageously avoiding transmission limitations and regulations requiring listening operations before transmitting in the communication channels.

In an embodiment, a method for advantageously avoiding redundant recaption time (e.g., listening-before-transmitting is provided). The method includes determining a first upcoming transmission from a device in a first communication channel during a first time window and determining a first aggregate parameter associated with transmissions of the device in the first communication channel during the first time window. The method also includes, in response to determining that the first aggregate parameter does not exceed the threshold parameter level, transmitting the first upcoming transmission in the first communication channel during the first time window without listening to the first communication channel.

In some embodiments, the threshold parameter level is based on the bandwidth of a communication channel and/or the transmitting power.

In accordance to an embodiment, a method includes: determining a first upcoming transmission from a device in a first communication channel during a first time window; determining a first aggregate parameter associated with transmissions of the device in the first communication channel during the first time window; and in response to determining that the first aggregate parameter does not exceed the threshold parameter level, transmitting the first upcoming transmission in the first communication channel during the first time window without listening to the first communication channel, which may advantageously allow for avoiding to perform channel sensing of the first communication channel while still complying with one or more regulations or requirements.

In accordance to an embodiment, a device includes: a transmitter circuit; and a processor coupled to the transmitter circuit and configured to: determine a first upcoming transmission from the device in a first communication channel during a first time window; determine a first aggregate parameter associated with transmissions of the device in the first communication channel during the first time window; and in response to determining that the first aggregate parameter does not exceed the threshold parameter level, transmit, via the transmitter circuit, the first upcoming transmission in the first communication channel during the first time window without listening to the first communication channel, which may advantageously allow for avoiding to perform channel sensing of the first communication channel while still complying with one or more regulations or requirements.

In accordance to an embodiment, a device includes: a transmitter circuit; a communication channel monitoring circuit; and a transmission control circuit; wherein the communication channel monitoring circuit is configured to: determine a first upcoming transmission from a device in a first communication channel during a first time window; determine a first aggregate parameter associated with transmissions of the device in the first communication channel during the first time window; and perform a comparison between the first aggregate parameter and the threshold parameter level and provide a result of the comparison to the transmission control circuit; and wherein the transmission control circuit is configured to, in response to the result being indicative that the first aggregate parameter does not exceed the threshold parameter level, transmit, via the transmitter circuit, the first upcoming transmission in the first communication channel during the first time window without listening to the first communication channel, which may advantageously allow for avoiding to perform channel sensing of the first communication channel while still complying with one or more regulations or requirements.

This Summary is provided to introduce a selection of concepts in a simplified form that are further described below in the Detailed Description. Some embodiments may implement one or more (or all) of the features described in this Summary. Some features described in this section may not be implemented by some embodiments, while still exhibiting advantages over prior art. This Summary is not intended to identify key features or essential features of the claimed subject matter, nor is it intended to be used to limit the scope of the claimed subject matter.

### BRIEF DESCRIPTION OF THE DRAWINGS

For a more complete understanding of the present invention(s), and the advantages thereof, reference is now made to the following descriptions taken in conjunction with the accompanying drawings, in which:

FIGS. 1A and 1B show operating environments, according to an embodiment of the present disclosure;

FIGS. 2A and 2B show methods for transmitting signals based on a threshold parameter level, according to an embodiment of the present disclosure;

FIG. 3 shows a sequence diagram of transmitting signals based on a threshold parameter level, according to an embodiment of the present disclosure; and

FIG. 4 shows an aspect of aggregating transmissions of a system, according to an embodiment of the present disclosure.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the invention(s), and do not limit the scope of the invention(s).

The description below illustrates the various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Embodiments of the present disclosure will be described in specific contexts, e.g., transmission configuration to avoid channel sensing, e.g., of a particular communication channel, e.g., using a frequency hopping techniques or using multi-frequency communication protocols, e.g. Bluetooth or Bluetooth Low Energy (BLE), Wi-Fi (e.g. Wi-Fi MLO) or Long Term Evolution (LTE). Some embodiments may be used in other applications, such as for transmitter or receiver parameter configuration, as well as using other wireless communication protocols and other open or restricted frequency bands. Some embodiments may be used in LAA applications. Some embodiments may be used in applications different from License Assisted Access (LAA).

In an embodiment, a device monitors and keeps track of transmissions from the device that are transmitted in a first channel that includes a first frequency. Upon request of a new transmission using the first channel during a first time window, the device determines an aggregate parameter (e.g., amount of data, transmitted power, etc.) associated with all transmissions from the device using the first channel during the first time window. When the aggregate parameter is lower than a first threshold level, the device proceeds with transmitting the new transmission without performing channel sensing of the first channel. When the aggregate parameter is higher than the first threshold, the device may delay transmission of the new transmission, schedule the new transmission using a different channel that does not include the first frequency, and/or modify a parameter associated with the new transmission so as to avoid performing channel sensing. In some embodiments, when the aggregate parameter is higher than the first threshold, the device performs sensing of the first channel for a duration of time that is proportional to a parameter (e.g., amount of data) associated with the new transmission. After the sensing of the first channel is performed, the device attempts to transmit the new transmission.

In an embodiment, a device monitors and keeps track of transmissions from the device that are transmitted in multiple channels that include a first frequency. The multiple channels may be of different wireless communication protocols (e.g., BLE and WiFi). Upon request of a new transmission using one of the multiple channels during a first time window, the device determines an aggregate parameter (e.g., amount of data, transmitted power, etc.) associated with all transmissions from the device in all of the multiple channels that include the first frequency during the first time window. When the aggregate parameter is lower than a first threshold level associated with the first frequency, the device proceeds with transmitting the new transmission without performing channel sensing. When the aggregate parameter is higher than the first threshold, the device may delay transmission of the new transmission, schedule the new transmission using a different channel that does not include the first frequency, and/or modify a parameter associated with the new transmission so as to avoid performing channel sensing.

Disclosed herein are embodiments related to improved communication systems, devices, and methods for transmitting signals, e.g., while advantageously avoiding channel sensing operations and transmitting within regulatory limitations. In an embodiment, a first device plans to establish communications with a second device by sending transmissions to the second device in a first communication channel during a first time window. The first device accumulates information about all transmissions in the first communication channel during the first time window and determines whether the aggregate information exceeds a threshold level based on regulatory limits. In some embodiments, the device transmits transmissions in the first communication channel during the first time window without performing communication channel sensing on the first communication channel. In some embodiments, the device transmits transmissions in a second communication channel during the first time window without performing communication channel sensing on the second communication channel. In some embodiments, the device transmits transmissions in the first communication channel during a second time window without performing communication channel sensing on the first communication channel. Each embodiment may advantageously reduce current consumption, power consumption, and increase battery life as the device does not perform communication channel sensing before each transmission. In some embodiments, the device performs communication channel sensing on the first communication channel for a duration based on the planned transmissions, which may include a duration less than the duration of the first time window. In this way, communication channel sensing during shortened, specific time windows advantageously reduces current and power consumption relative to existing channel sensing techniques while still conforming to regulatory requirements.

In an example embodiment, a method for advantageously avoiding listening-before-transmitting is provided. The method includes determining a first upcoming transmission from a device in a first communication channel during a first time window and determining a first aggregate parameter associated with transmissions of the device in the first communication channel during the first time window. The method also includes, in response to determining that the first aggregate parameter does not exceed the threshold parameter level, transmitting the first upcoming transmission in the first communication channel during the first time window without listening to the first communication channel.

In another example embodiment, a device including a transmitter circuit and a processor is provided. The processor is coupled to the transmitter circuit and is configured to determine a first upcoming transmission from the device in a first communication channel during a first time window, determine a first aggregate parameter associated with transmissions of the device in the first communication channel during the first time window, and in response to determining that the first aggregate parameter does not exceed the threshold parameter level, transmit, via the transmitter circuit, the first upcoming transmission in the first communication channel during the first time window without listening to the first communication channel.

In yet another example embodiment, a device including a transmitting circuit, a communication channel monitoring circuit, and a transmission control circuit is provided. The communication channel monitoring circuit is configured to determine a first upcoming transmission from a device in a first communication channel during a first time window, determine a first aggregate parameter associated with transmissions of the device in the first communication channel during the first time window, and perform a comparison between the first aggregate parameter and the threshold parameter level and provide a result of the comparison to the transmission control circuit. The transmission control circuit is configured to, in response to the result being indicative that the first aggregate parameter does not exceed the threshold parameter level, transmit, via the transmitter circuit, the first upcoming transmission in the first communication channel during the first time window without listening to the first communication channel.

In yet another example embodiment, a method for transmitting signals after listening to a communication channel is provided. The method includes determining a first upcoming transmission from a device in a first communication channel during a first time window and determining a first aggregate parameter associated with transmissions of the device in the first communication channel during the first time window. In response to determining that the first aggregate parameter does not exceed the threshold parameter level, the method includes transmitting the first upcoming transmission in the first communication channel during the first time window without listening to the first communication channel. In response to determining that the first aggregate parameter exceeds the threshold parameter level, the method includes listening to the first communication channel during the first time window to generate a first listening result and transmitting the first upcoming transmission in the first communication channel based on the first listening result.

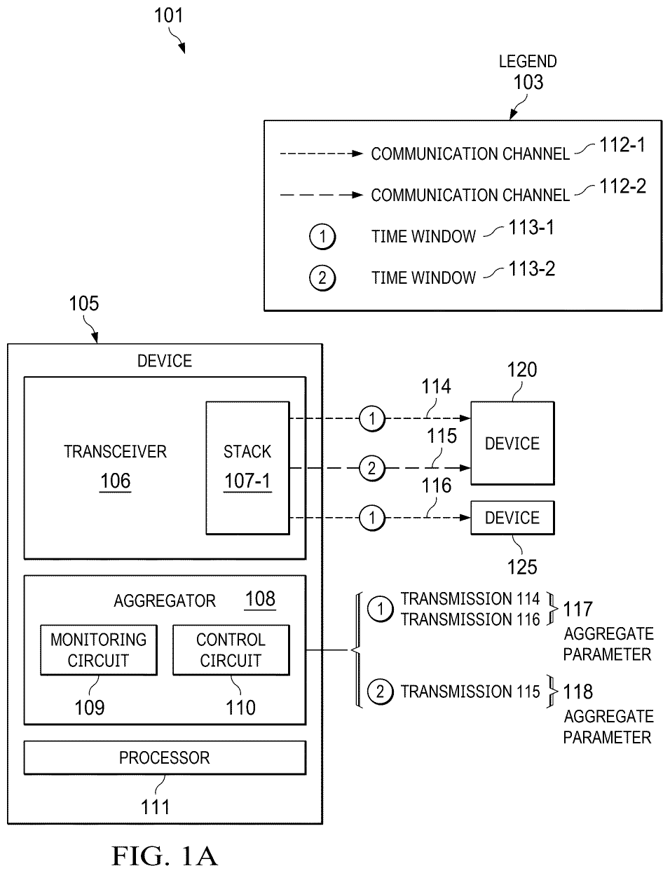

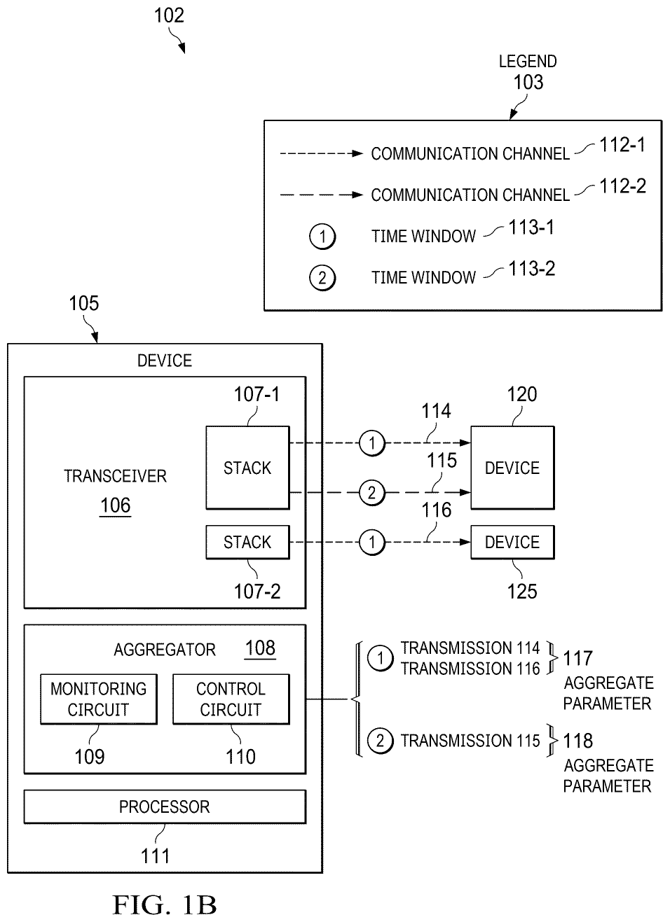

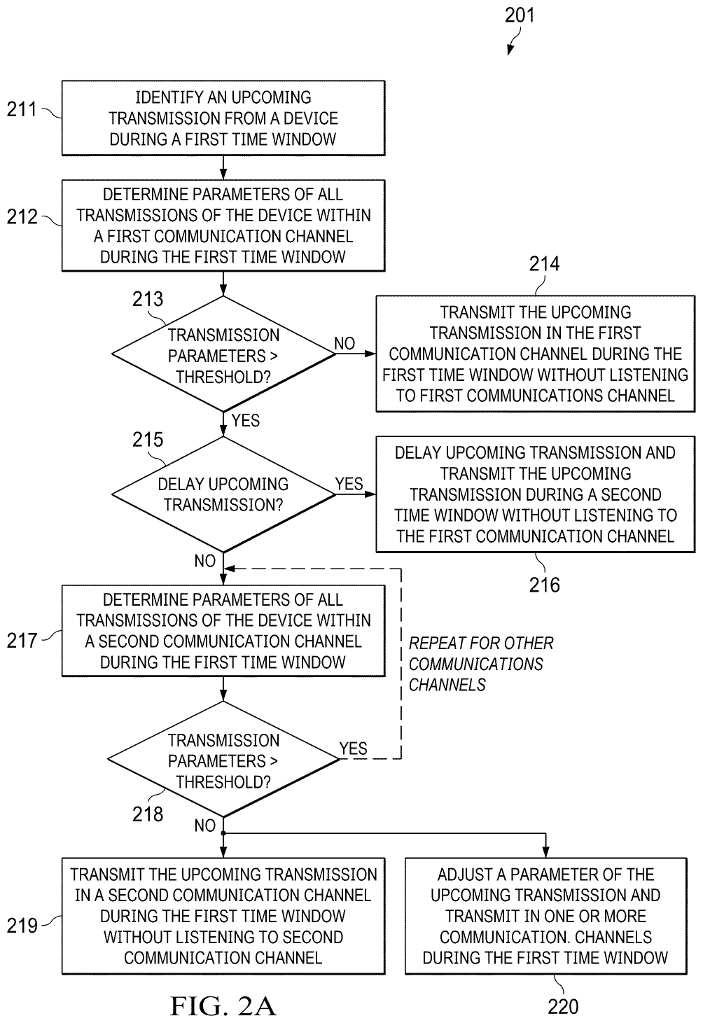

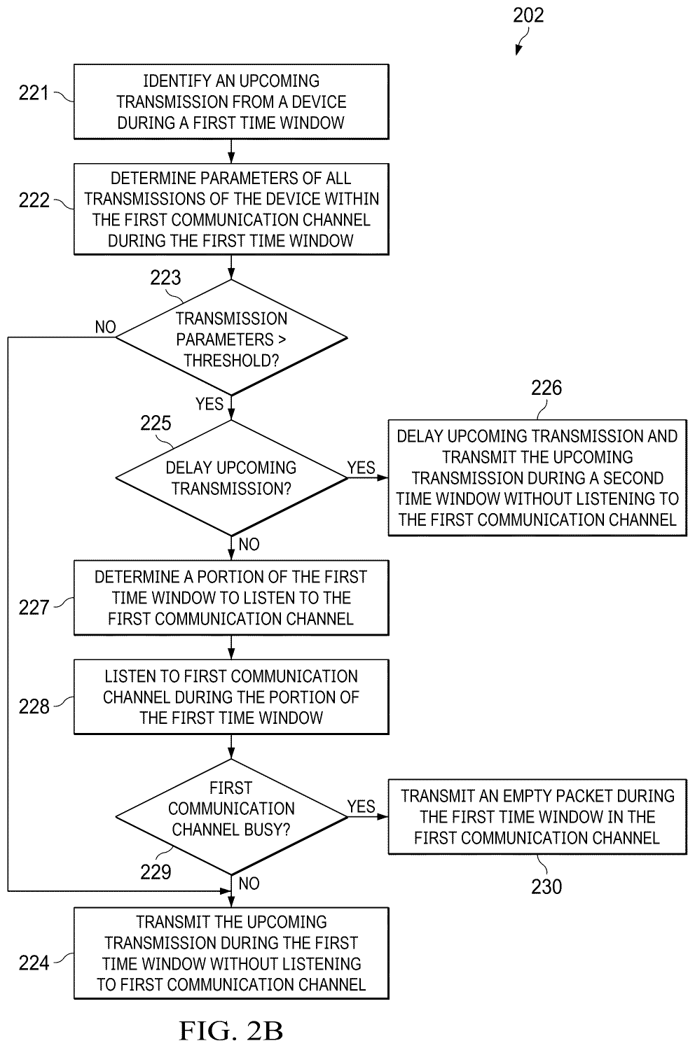

FIGS. 1A and 1B show operating environments, according to an embodiment of the present disclosure. FIG. 1A shows operating environment 101, and FIG. 1B shows operating environment 102, which both include device 105, device 120, and device 125 in communication with each other. Device 105 includes transceiver 106, aggregator 108, and processor 111. Aggregator 108 includes monitoring circuit 109 and control circuit 110. In various embodiments, elements of operating environments 101 and 102 may be configured to transmit signals to devices and perform frequency management operations corresponding to the transmissions, such as operations 201 and 202 of FIGS. 2A and 2B. Accordingly, device 105 may perform such processes on hardware, software, firmware, or combinations or variations thereof.

Referring first to FIG. 1A, operating environment 101 is representative of an environment including devices 105, 120, and 125 in wireless communication with each other. Device 105 may be representative of a device, apparatus, or system capable of transmitting and receiving signals, e.g., to and from devices 120 and 125 using one or more communication channels of one or more communication protocols, such as Bluetooth, BLE, Wi-Fi, LTE, and the like, and one or more protocol stacks thereof. Similarly, devices 120 and 125 may be representative of devices, apparatuses, or systems capable of transmitting and receiving signals to and from device 105 via the communication protocol(s) and stack(s).

In various embodiments, device 105 includes components capable of establishing such wireless communications with devices 120 and 125, scheduling the wireless communications thereof, determining whether the wireless communications fall within regulatory limits, and performing transmissions or listening operations based on parameters of the transmissions relative to threshold parameter levels associated with communication channels. For example, device 105 includes transceiver 106, aggregator 108, and processor 111.

Transceiver 106 may be representative of one or more components capable of transmitting, receiving, and processing signals, e.g., communicated over a wireless network. In some embodiments, transceiver 106 may include one or more antennas, transmit circuitry and receiver circuitry, logic devices, amplifiers and buffers, filters, analog-to-digital converters, and the like. In some embodiments, transceiver 106 may communicate with devices 120 and 125 using multiple communication channels (communication channels 112-1 and 112-2 (collectively communication channels 112)) of a single protocol stack (stack 107-1). More specifically, in some embodiments, transceiver 106 may transmit transmissions 114 and 115 (e.g., packets or frames) to device 120 via stack 107-1 and transmission 116 to device 125 via stack 107-1. Transceiver 106 may transmit transmissions 114 and 116 during a first time window 113-1 and transmission 115 during a second time window 113-2. In such embodiments, communication channels 112 may include a range of frequency channels or bands within a single communication protocol, or they may include frequency channels across multiple communication protocols.

Aggregator 108 may be representative of one or more components capable of determining upcoming transmissions from device 105 (i.e., via transceiver 106) (e.g., transmission 114) across communication channels 112 and during time windows 113, determining parameters (e.g., aggregate parameter 117, aggregate parameter 118) of all transmissions from device 105 on each communication channel, and controlling operations of transceiver 106 based on the parameters at a given time. In some embodiments, aggregator 108 includes monitoring circuit 109 and control circuit 110, e.g., to perform such operations.

Monitoring circuit 109 may be representative of a circuit capable of monitoring each communication channel across communication protocols and stacks and identifying current and upcoming transmissions corresponding to each communication channel. In particular, monitoring circuit 109 may monitor previous, current, and upcoming activity (i.e., transmissions) in various frequency sets in which transceiver 109 can operate. In some embodiments, monitoring circuit 109 may include an interface or may interface with transceiver 106 and other devices via an application programming interface (API), e.g., to perform such operations. In some embodiments, monitoring circuit 109 may be further configured to perform listening operations on a communication channel, such as a listen-before-talk operation or a detect-and-avoid operation, among other channel sensing operations.

Control circuit 110 may be representative of a circuit capable of controlling operations of monitoring circuit 109 and transceiver 106. In some embodiments, controlling transceiver 106 may entail controlling transceiver 106 to transmit a transmission in a certain communication channel using a specific protocol or stack and during a time window. In other words, in some embodiments, control circuit 110 may modify local (i.e., device level) and link (i.e., connection or device-to-device level) parameters of transmissions to be transmitted by transceiver 106. In some embodiments, controlling monitoring circuit 109 may entail controlling monitoring circuit 109 to perform one or more of the listening operations to determine whether a communication channel is busy before controlling transceiver 106 to transmit a transmission in the given communication channel.

In some embodiments, the functions performed by aggregator 108 may be performed by processor 111.

Processor 111 may be representative of one or more processors or processing cores capable of controlling transceiver 106 and aggregator 108 and other aspects of device 105. In some embodiments, processor 111 may be implemented as a generic or custom controller or processor coupled to a memory and capable of executing instructions stored in the memory. In some embodiments, examples of processor 111 may include one or more generic or custom microcontrollers, DSPs, general purpose central processing units, application specific processors or circuits (e.g., ASICs), and/or logic devices (e.g., FPGAs), as well as any other type of processing device, combinations, or variations thereof.

In some embodiments, processor 111, aggregator 108, and transceiver 106 may be implemented in the same package as part of the same integrated circuit (IC). In some embodiments, part or all of transceiver 08 and/or aggregator 108 may be implemented separated from the IC including processor 111.

In some embodiments, one or more antennas (not shown) coupled to transceiver 106 are implemented external to the IC containing transceiver 106.

In some embodiments, additional circuitry may be included in or external to devices 105, 120, and 125. For example, in some embodiments, devices 105, 120, and 125 may include or use one or more antennas located externally to devices 105, 120, and 125 to facilitate communications between device 105 and device 120 and device 105 and device 125. In some embodiments, devices 120 and 125 may also include elements included in device 105 to perform similar functions.

In operation, transceiver 106 of device 105 may be configured to send transmission 114 to device 120 via communication channel 112-1 during time window 113-1, transmission 115 to device 120 via communication channel 112-2 during time window 113-2, and transmission 116 to device 125 via communication channel 112-1 during time window 113-1. Prior to transmitting any of transmissions 114, 115, and 116, aggregator 108 may be configured to identify an upcoming transmission from transceiver 106 within a specific communication channel and during a certain time window and determine parameters of all transmissions from transceiver 106 within the communication channel during the respective time window, including transmissions scheduled or otherwise expected to be transmitted and transmissions already transmitted during the respective time window. The following discussion relates to examples of performing such functions. In some embodiments, the functions may be implemented in hardware, and as such, may be performed by aggregator 108 and corresponding circuitry. In some embodiments, the functions may be implemented in software, and as such, processor 111 may direct components of device 105, such as aggregator 108, to perform various operations. Other variations and combinations may also be contemplated.

By way of a first example, aggregator 108 may identify transmission 114 as an upcoming transmission in communication channel 112-1 to be transmitted during time window 113-1. Accordingly, aggregator 108 may determine aggregate parameter 117 which includes parameters of both transmissions 114 and 116, as well as any other transmissions scheduled or otherwise expected to be transmitted or already transmitted using frequencies associated with communication channel 112-1, as both transmissions 114 and 116 may be scheduled to occur in communication channel 112-1 during time window 113-1. By way of a second example, aggregator 108 may identify transmission 115 as an upcoming transmission in communication channel 112-2 during time window 113-2. Accordingly, aggregator 108 may determine aggregate parameter 118 which includes parameters of transmission 115 during time window 113-2. In various embodiments, aggregate parameters 117 and 118 include information associated with transmissions 114, 115, and 116, such as actual usage (e.g., on each potential frequency or frequency band) within a communication channel. Examples of such information may include a number of transmissions from device 105, a size of the upcoming transmissions (e.g., size of a header, size of a payload), a duration of the upcoming transmissions, a power of the upcoming transmissions (e.g., local transmission power, end point transmission power), and an operation (e.g., used frequency set, order).

In various embodiments, based on determining the aggregate parameters, aggregator 108 may be configured to determine whether the aggregate parameters exceed threshold parameter levels of each communication channel. More particularly, in some embodiments, the first threshold parameter level may be associated with one or more frequencies of each communication channel. By way of example, in some such embodiments, communication channel 112-1 may be associated with a Bluetooth communication protocol. Transmissions in communication channel 112-1 during time window 113-1 may include transmissions in accordance with a Bluetooth channel (e.g., BLE channel 17) that includes a center frequency of 2440 MHz and a bandwidth of 2 MHz and transmissions in accordance with a WiFi channel (e.g., WiFi channel 6) that includes a center frequency of 2462 MHz and a bandwidth of 22 MHz. While both channels have different center frequencies and bandwidths, aggregator 108 may be configured to determine aggregate parameter 117 and the first threshold parameter level based on transmissions associated with a frequency of 2440 MHZ in such embodiments.

In some embodiments, the threshold parameter levels may be based on a government regulatory limit. For example, the threshold parameter levels may be based on a limit set out in the United States Code of Federal Regulations (CFR) (e.g., 47 CFR Chapter I, Subchapter A, Part 15, Subpart E (related to radio frequency devices and unlicensed national information infrastructure devices)), the Telecommunications Standard Institute (ETSI), the American National Standard for Evaluation of Wireless Coexistence, or the like, such as limits related to transmission power, transmission power control, dynamic frequency selection, channel access mechanisms (e.g., frame-based equipment mechanism, load-based equipment mechanism), as well as similar regulatory guidelines and limit set out in other countries, such as in countries of the European Union, China, Japan, Taiwan, Korea, and others.

Following the first example above, aggregator 108 may be configured to perform a comparison between aggregate parameter 117 to a first threshold parameter level associated with communication channel 112-1. In response to determining that aggregate parameter 117 does not exceed the first threshold parameter level, aggregator 108 may be configured to direct transceiver 106 to transmit transmission 114 in communication channel 112-1 during time window 113-1 without listening to or otherwise performing communication channel sensing of communication channel 112-1. Similarly, following the second example, aggregator 108 may be configured to perform a comparison between aggregate parameter 118 to a second threshold parameter level associated with communication channel 112-2. In response to determining that aggregate parameter 118 does not exceed the second threshold parameter level, aggregator 108 may be configured to direct transceiver 106 to transmit transmission 115 in communication channel 112-2 during time window 113-2 without listening to communication channel 112-2.

In some embodiments, the first and second threshold parameter levels are equal.

In some embodiments, in response to determining that aggregate parameter 117 exceeds the first threshold parameter level, aggregator 108 may be configured to direct transceiver 106 to transmit transmission 114 during a different time window, with different parameters, or using a different communication channel, e.g., to avoid performing communication channel sensing of any communication channel prior to transmission of transmitting transmission 114.

For example, in some embodiments, aggregator 108 may be configured to direct transceiver 106 to delay transmission 114 to another time window, such as time window 113-2, and transmit transmission 114 in communication channel 112-1 during the other time window. In such embodiments, aggregator 108 might not listen to communication channel 112-1 before directing transceiver 106 to transmit transmission 114 in communication channel 112-1.

In some embodiments, time windows 113-1 and 113-2 may have the same duration. In some embodiments, time windows 113-1 and 113-2 may have different durations. Regardless of durations, in some embodiments, time window 113-2 may partially overlap with time window 113-1. In some embodiments, time windows 113-1 and 113-2 may be sliding time windows. In some embodiments, time windows 113-1 and 113-2 may be fixed time windows that are sequential in time.

In some embodiments, aggregator 108 may be configured to direct transceiver 106 to transmit transmission 114 in communication channel 112-2 during time window 112-1 without listening to communication channel 112-2. In some such embodiments, aggregator 108 may first be configured to perform a comparison between aggregate parameter 118 and the second threshold parameter level, and based on aggregate parameter 118 falling below the second threshold parameter level, direct transceiver 106 to transmit transmission 114 in communication channel 112-2 during time window 112-1. In some such embodiments, aggregator 108 may be further configured to direct transceiver 106 to transmit transmission 114 in multiple communication channels. For example, aggregator 108 may be configured to adjust a list of channels of a frequency hopping sequence associated with the communication protocol of communication channels 112, such that the list of channels includes multiple channels and/or a different sequence of channels. By (e.g., dynamically) adapting the selection of channels of the list of channels, some embodiments may advantageously continue to perform transmissions without performing channel sensing (e.g., by scheduling the transmission such that the aggregate transmissions per channel/frequency do not exceeds their associated threshold level).

In some embodiments, transceiver 106 may be configured to transmit a first transmission (e.g., transmission 114) in a communication channel (e.g., communication channel 112-1) associated with a first communication protocol repeatedly every first time during a time window (e.g., time window 113-1). In some such embodiments, aggregator 108 may be configured to modify the first time, the duration of the first transmission, and/or the parameters of the first transmission in response to determining that an aggregate parameter that includes parameters of this first transmission, among other transmissions to be transmitted during the time window, exceeds a threshold parameter level. For example, in some embodiments, the period between transmissions may be increased to a level that avoids exceeding the threshold parameter level in a particular time window.

In some embodiments, aggregator 108 may be configured to use a Multi-Link operation to distribute transmission 114 among multiple communication channels of the communication protocol. By spreading transmissions over multiple channels/frequencies, some embodiments may advantageously continue to perform transmissions without performing channel sensing (e.g., by scheduling the transmission such that the aggregate transmissions per channel/frequency do not exceeds their associated threshold level). In some embodiments, the Multi-Link operation may be performed in accordance with an LTE communication protocol.

In some embodiments, the threshold level may be based on the transmission power level or other transmission parameters. In some such embodiments, aggregator 108 may be configured to identify one or more parameters different from current parameters of transmission 114 (e.g., a reduced power), configure transmission 114 with the one or more different parameters, and direct transceiver 106 to transmit transmission 114 in communication channel 112-1 during time window 112-2 using the one or more different parameters, e.g., to avoid exceeding the associated threshold level. In this way, the aggregate parameter associated with communication channel 112-1 following a re-configuration of parameters of transmission 114 may be lower than aggregate parameter 117 and the threshold parameter level of communication channel 112-1, which may advantageously avoid exceeding the associated threshold level, which may thereby advantageously allow for the transmission to proceed without performing channel sensing.

In some embodiments, aggregator 108 may be configured to transmit another transmission in communication channel 112-1 during time window 113-1 in addition to transmissions 114 and 116. However, in such embodiments, the aggregate parameter may be different than aggregate parameter 117. Aggregator 108 may be configured to perform a first comparison between aggregate parameter 117 and the first threshold parameter level and a second comparison between the different aggregate parameter and the first threshold parameter level. Based on aggregate parameter 117 and/or the different aggregate parameter exceeding the first threshold parameter level, aggregator 108 may be configured to perform delay or adjustment techniques to avoid performing a listening operation before transmitting either or both the additional transmission and transmissions 114 and 116, such as the techniques described above.

Other variations or combinations of communication channels, time windows, and transmission parameters may be contemplated for use by transceiver 106 such that aggregator 108 does not perform a listening operation before directing transceiver 106 to transmit one or more transmissions in a communication channel during a time window.

In various embodiments, aggregator 108 may perform a listening operation before directing transceiver 106 to transmit any transmissions. Following the first example again, in an embodiment, in response to determining that aggregate parameter 117 exceeds the first threshold parameter level, aggregator 108 may be configured to determine a portion of time window 113-1 to listen to communication channel 112-1. The portion of time window 113-1 may correspond to a duration based on transmission 114. More particularly, the duration may include a length of time proportional to an amount of data of transmission 114 or to a duration of transmission 114. In some embodiments, transmission 114 may include a re-transmission rate such that some portions of signals or data is re-transmitted during transmission of transmission 114. Thus, the duration may also be based on the re-transmission rate associated with transmission 114. In some embodiments, the duration may include a length of time based on a bit error rate (BER) associated with communication channel 112-1.

Next, aggregator 108 may be configured to listen to communication channel 112-1 during the portion of time window 113-1 to generate a listening result. In some embodiments, this may entail performing a listen-before-talk operation, a detect-and-avoid operation, or another channel sensing operation. Based on the listening result, aggregator 108 may be configured to determine whether communication channel 112-1 is busy. In response to the listening result being indicative of communication channel 112-1 not being busy, aggregator 108 may direct transceiver 106 to transmit transmission 114 in communication channel 112-1 during time window 113-1. In response to the listening result being indicative of communication channel 112-1 being busy, aggregator 108 may direct transceiver 106 to transmit a signal different from transmission 114 (e.g., an empty packet) in communication channel 112-1, e.g., during time window 113-1.

Referring next to FIG. 1B, in operating environment 102, elements of device 105 may be configured to operate in similar ways as described with respect to operating environment 101. In operating environment 102, however, transceiver 106 may be configured to communicate with devices 120 and 125 using multiple communication channels (communication channels 112-1 and 112-2) of a protocol including multiple stacks (stacks 107-1 and 107-2 (collectively stacks 107)). For example, in some embodiments, transceiver 106 may transmit transmissions 114 and 115 to device 120 via stack 107-1 and transmission 116 to device 125 via stack 107-2. Transceiver 106 may transmit transmissions 114 and 116 during a first time window 113-1 and transmission 115 during a second time window 113-2. In some such embodiments, communication channels 112 may include frequency channels within a single communication protocol or may include frequency channels across multiple communication protocols. As such, in response to aggregate parameter 117 or aggregate parameter 118 exceeding a respective threshold parameter level, aggregator 108 may be configured to direct transceiver 106 to perform transmissions using various combinations of time windows, parameters, and communication channels, including across stacks 107-1 and 107-2.

In some embodiments, stack 107-1 and stack 107-2 correspond to the same communication protocol. In some embodiments, stack 107-1 and stack 107-2 correspond to different communication protocols.

In some embodiments, each communication protocol and each stack of each communication protocol may be associated with an aggregate parameter. In some such embodiments, an aggregate parameter in one stack of a communication protocol may be different from aggregate parameters of other communication protocols and stacks. Thus, aggregator 108 may be configured to compare each aggregate parameter to a respective threshold parameter level and direct transceiver 106 to perform transmissions using various combinations of time windows, parameters, and communication channels/protocols/stacks based on aggregate parameters exceeding respective threshold parameter levels. In some embodiments, aggregator 108 may aggregate multiple aggregate parameters (e.g., from different stacks and/or protocols) associated with a particular frequency to determine whether the aggregated aggregate parameter exceeds the threshold level associated with such particular frequency.

Although FIGS. 1A and 1B illustrate device 105 transmitting transmissions 114 and 115 to device 120, and transmission 116 to device 125 receiving transmission 116, in some embodiments, device 105 may transmit all transmissions to the same device (e.g., all to device 120) or each transmission to a different device (e.g., transmission 114 to device 120, transmission 116 to device 125, and transmission 115 to another device not shown).

FIGS. 2A and 2B show methods for transmitting signals based on a threshold parameter level, according to an embodiment of the present disclosure. FIG. 2A shows operations 201, which reference elements of FIGS. 1A and 1B. FIG. 2B shows operations 202, which also reference elements of FIGS. 1A and 1B. Operations 201 and 202 may be implemented in software, hardware, and/or firmware, or combinations or variations thereof. In some embodiments, operations 201 and 202 may be implemented in elements of operating environments 101 and 102.

Referring first to operations 201 of FIG. 2A, in operation 211, aggregator 108 identifies transmission 114 as an upcoming transmission from device 105 to be transmitted during a first time window 113-1. In various embodiments, device 105, via transceiver 106, may communicate with devices 120 and 125 using multiple communication channels (communication channels 112-1 and 112-2 (collectively communication channels 112)) of a single or a multiple protocol stack (e.g., stack 107-1, stack 107-2). For example, in some embodiments, transceiver 106 may transmit transmissions 114 and 116 during a first time window 113-1 and transmission 115 during a second time window 113-2. In some such embodiments, communication channels 112 may include frequency channels within a single communication protocol, or they may include frequency channels across multiple communication protocols.

In operation 212, aggregator 108 determines aggregate parameter 117, which may include all parameters of transmissions from device 105 scheduled or otherwise expected to be transmitted, or already transmitted using frequencies associated with communication channel 112-1 during the first time window 113-1. In some embodiments, such transmissions may take place in a single stack of a first protocol, in multiple stacks of the first protocol, or in multiple stacks of different protocols. In various embodiments, aggregate parameter includes information associated with transmissions using one or more frequencies within communication channel 112-1 (e.g., including transmissions 114 and 116), like a number of transmissions from device 105 within a particular frequency of a communication channel 112-1, a size of the upcoming transmissions in the communication channel 112-1, a duration of the upcoming transmissions in communication channel 112-1, or a power of the upcoming transmissions in communication channel 112-1. It follows that each transmission includes individual parameters.

In some embodiments that track past transmissions, information indicative of past transmissions and/or aggregate parameters associated with past transmissions may be stored locally (e.g., in a local memory of device 105), and may be used to compute new aggregate parameters (e.g., associated with a new time window that may cover at least some of such past transmissions).

In operation 213, based on determining aggregate parameter 117, aggregator 108 may be configured to determine whether aggregate parameter 117 exceeds a first threshold parameter level associated with communication channel 112-1. More particularly, in some embodiments, the first threshold parameter level may be associated with one or more frequencies of communication channel 112-1. By way of example, in some such embodiments, communication channel 112-1 may be associated with a Bluetooth communication protocol. Transmissions in communication channel 112-1 during time window 113-1 may include transmissions in accordance with a Bluetooth channel (e.g., BLE channel 17) that includes a center frequency of 2440 MHz and a bandwidth of 2 MHz and transmissions in accordance with a WiFi channel (e.g., WiFi channel 6) that includes a center frequency of 2462 MHz and a bandwidth of 22 MHz. While both channels have different center frequencies and bandwidths, aggregator 108 may be configured to determine aggregate parameter 117 and the first threshold parameter level based on transmissions associated with a frequency of 2440 MHz in some such embodiments.

In some such embodiments, the first threshold parameter level may be based on a government regulatory limit. For example, the threshold parameter level may be based on a limit set out in the United States Code of Federal Regulations (CFR) (e.g., 47 CFR Chapter I, Subchapter A, Part 15, Subpart E (related to radio frequency devices and unlicensed national information infrastructure devices)), the Telecommunications Standard Institute (ETSI), the American National Standard for Evaluation of Wireless Coexistence, or the like, as well as similar regulatory guidelines and limit set out in other countries, such as in countries of the European Union, China, Japan, and others.

In response to determining that aggregate parameter 117 does not exceed the first threshold parameter level, in operation 214, aggregator 108 may direct transceiver 106 to transmit transmission 214 in communication channel 112-1 during the first time window 113-1 without listening to or otherwise sensing communication channel 112-1.

In response to determining that aggregate parameter 117 exceeds the first threshold parameter level, in operation 215, aggregator 108 may direct transceiver 106 to delay transmission 114 to a later time (e.g., to a different time window), transmit transmission 114 in a different communication channel and/or with adjusted parameters. If aggregator 108 determines to delay transmission 114, aggregator 108, in operation 216, may be configured to identify another time window (e.g., time window 113-2) and direct transceiver 106 to transmit transmission 114 in communication channel 112-1 during the other time window, e.g., without listening to communication channel 112-1. If aggregator 108 determines not to delay transmission 114, aggregator 108, in operation 217, may determine aggregate parameter 118. In other words, aggregator 108 may determine, e.g., all parameters of transmissions from device 105 within communication channel 112-2 during the first time window 113-1. In this example, aggregate parameter 118 may include information about transmission 115.

In operation 218, aggregator 108 may determine whether aggregate parameter 118 exceeds a second threshold parameter level associated with communication channel 112-2. If aggregator 108 determines that aggregate parameter 118 exceeds the second threshold parameter level, aggregator 108 may repeat operation 217 for other communication channels during the first time window 113-1. If aggregator 108 determines that aggregate parameter 118 falls below the second threshold parameter level, aggregator 108, in operation 219, may be configured to direct transceiver 106 to transmit transmission 114 in communication channel 112-2 during time window 113-1 without listening to communication channel 112-2. Alternatively, if aggregator 108 determines that aggregate parameter 118 falls below the second threshold parameter level, aggregator 108, in operation 220, may be configured to adjust one or more parameters of transmission 114 (e.g., transmission power, transmission duration, transmission size) and transmit transmission 114 in one or more of communication channels 112 during time window 113-1. In some embodiments, aggregator 108 may direct transceiver 106 to transmit transmission 114 in communication channel 112-1, in communication channel 112-2, or in both communication channels 112-1 and 112-2.

In some embodiments where aggregator 108 is configured to direct transceiver 106 to transmit transmission 114 in multiple communication channels 112, aggregator 108 may be configured to adjust a list of channels of a frequency hopping sequence associated with the communication protocol (e.g., BLE, 802.15.4-based protocols, or other, e.g., proprietary protocols) of communication channels 112, such that the list of channels includes multiple channels and/or a different sequence of channels. In some embodiments, aggregator 108 may be configured to use a Multi-Link operation, e.g., according to IEEE 802.11 standard, to distribute transmission 114 among multiple communication channels 112 of the communication protocol.

Referring next to operations 202 of FIG. 2B, in operation 221, aggregator 108 identifies transmission 114 as an upcoming transmission from device 105 during a first time window 113-1. In operation 222, aggregator 108 determines aggregate parameter 117, which may include all parameters of transmissions from device 105 within communication channel 112-1 during the first time window 113-1.

In operation 223, based on determining aggregate parameter 117, aggregator 108 may be configured to determine whether aggregate parameter 117 exceeds the first threshold parameter level. In response to determining that aggregate parameter 117 does not exceed the first threshold parameter level, in operation 224, aggregator 108 may direct transceiver 106 to transmit transmission 214 in communication channel 112-1 during the first time window 113-1 without listening to communication channel 112-1.

In response to determining that aggregate parameter 117 exceeds the first threshold parameter level, in operation 225, aggregator 108 may direct transceiver 106 to delay transmission 114 to a different time window or to perform a listening operation on communication channel 112-1 prior to transmitting transmission 114 in communication channel 112-1 during time window 113-1.

If aggregator 108 determines to delay transmission 114, aggregator 108, in operation 226, may be configured to identify another time window (e.g., time window 113-2) and direct transceiver 106 to transmit transmission 114 in communication channel 112-1 during the other time window without listening to communication channel 112-1. If aggregator 108 determines not to delay transmission 114, aggregator 108, in operation 227, can determine a portion of time window 113-1 to listen to communication channel 112-1. The portion of time window 113-1 may correspond to a duration based on transmission 114. For example, in some embodiments, the duration may include a length of time proportional to an amount of data of transmission 114 or to a duration of transmission 114. In some embodiments, transmission 114 may include a re-transmission rate such that some portions of signals or data is re-transmitted during transmission of transmission 114. Thus, in some embodiments, the duration may be based on the re-transmission rate associated with transmission 114. In some embodiments, the duration may include a length of time based on a bit error rate (BER) associated with communication channel 112-1.

Next, in operation 228, aggregator 108 may be configured to listen to communication channel 112-1 during the portion of time window 113-1 to generate a listening result. In some embodiments, this may entail performing a listen-before-talk operation, a detect-and-avoid operation, or another channel sensing operation. Based on the listening result, aggregator 108 may be configured to determine whether communication channel 112-1 is busy. In response to the listening result being indicative of communication channel 112-1 not being busy, aggregator 108, in operation 229, may direct transceiver 106 to transmit transmission 114 in communication channel 112-1 during time window 113-1 such as in operation 224. In response to the listening result being indicative of communication channel 112-1 being busy, aggregator 108, in operation 229, may direct transceiver 106 to transmit a signal different from transmission 114 (e.g., an empty packet) in communication channel 112-1 during time window 113-1 as in operation 230.

It may be appreciated that operations 201 and 202 may be repeated for any number of transmissions during any time window, such that device 105 can continue to transmit to other devices without listening to a communication channel ahead of time unless necessary based on regulatory requirements. Advantageously, by implementing operations 201 and/or 202, device 105 can save time and power by sending transmissions without listening to communication channels.

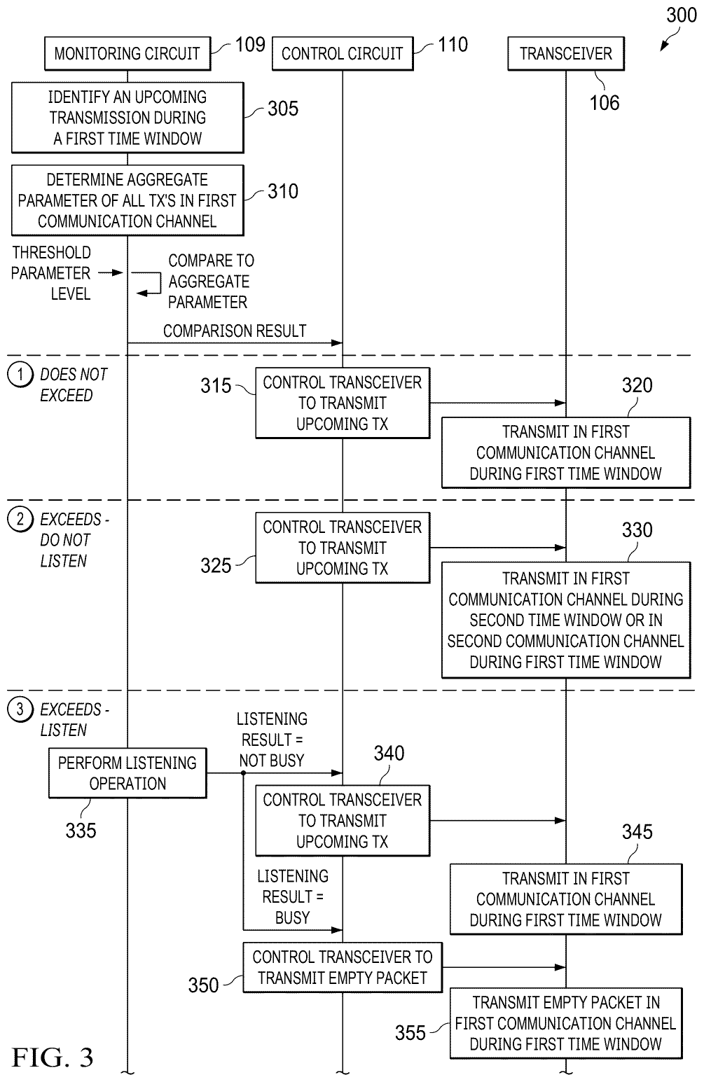

FIG. 3 shows a sequence diagram of transmitting signals based on a threshold parameter level, according to an embodiment of the present disclosure. FIG. 3 shows sequence 300, which references elements of FIGS. 1A and 1B. In various embodiments, the elements of FIGS. 1A and 1B, such as monitoring circuit 109, control circuit 110, and transceiver 106, may perform operations of sequence 300.

In step 305 of sequence 300, monitoring circuit 109 of aggregator 108 may be configured to identify an upcoming transmission from transceiver 106 within a specific communication channel and for transmission during a certain time window. In an embodiment, transceiver 106 of device 105 may be configured to send transmission 114 to device 120 via communication channel 112-1 during time window 113-1, transmission 115 to device 120 via communication channel 112-2 during time window 113-2, and transmission 116 to device 125 via communication channel 112-1 during time window 113-1. Accordingly, monitoring circuit 109 may identify transmission 114 as the upcoming transmission in communication channel 112-1 during time window 113-1.

In step 310, monitoring circuit 109 may determine aggregate parameter 117, which includes parameters of both transmissions 114 and 116, as well as any other transmissions scheduled or otherwise expected to be transmitted or already transmitted using frequencies associated with communication channel 112-1, as both transmissions 114 and 116 may be scheduled to occur in communication channel 112-1 during time window 113-1. Based on determining aggregate parameter 117, monitoring circuit 109 may be configured to determine whether aggregate parameter 117 exceeds a threshold parameter level associated with communication channel 112-1. In some such embodiments, the threshold parameter level may be based on a government regulatory limit. In determining whether aggregate parameter 117 exceeds the threshold parameter, monitoring circuit 109 may be configured to perform a comparison between aggregate parameter 117 and the threshold parameter level. Monitoring circuit 109 may provide the comparison result to control circuit 110, and monitoring circuit 109 and/or control circuit 110 may perform various actions based on the comparison result.

In a first scenario where aggregate parameter 117 does not exceed the threshold parameter level as indicated by the comparison result, in step 315, control circuit 110 may be configured to direct transceiver 106 to transmit transmission 114 in communication channel 112-1 during time window 113-1 without listening to communication channel 112-1. In step 320, transceiver 106 may transmit transmission 114 in communication channel 112-1 during time window 113-1.

In a second scenario where aggregate parameter 117 exceeds the threshold parameter level as indicated by the comparison result, monitoring circuit 109 may nevertheless be configured to not listen to communication channel 112-1 prior to transmission of transmission 114. For example, in some embodiments, in step 325, control circuit 110 may be configured to direct transceiver 106 to transmit transmission 114 in communication channel 112-1 during a second time window (e.g., time window 113-2). In some embodiments, control circuit 110 may be configured to direct transceiver 106 to transmit transmission 114 in a second communication channel (e.g., communication channel 112-2) during time window 113-1. Other combinations or variations may be contemplated. In step 330, transceiver 106 may transmit transmission 114 during time window 113-2 or in communication channel 112-2 during time window 113-1.

In a third scenario where aggregate parameter 117 exceeds the threshold parameter level as indicated by the comparison result, in step 335, monitoring circuit 109 may be configured to perform a listening operation (e.g., a listen-before-talk operation, a detect-and-avoid operation) before transceiver 106 to outputs any transmissions. In various embodiments, monitoring circuit 109 may perform the listening operation during a portion of time window 113-1. Accordingly, monitoring circuit 109 may be configured to determine the portion of time window 113-1 to listen to communication channel 112-1. The portion of time window 113-1 may correspond to a duration based on transmission 114. More particularly, the duration may include a length of time proportional to an amount of data of transmission 114 or to a duration of transmission 114. In some embodiments, transmission 114 may include a re-transmission rate such that some portions of signals or data is re-transmitted during transmission of transmission 114. Thus, the duration may be based on the re-transmission rate associated with transmission 114. In some embodiments, the duration may include a length of time based on a bit error rate (BER) associated with communication channel 112-1. Then, monitoring circuit 109 may be configured to listen to communication channel 112-1 during the portion of time window 113-1 to generate a listening result and provide the listening result to control circuit 110.

If the listening result is indicative of communication channel 112-1 not being busy, in step 340, control circuit 110 may be configured to direct transceiver 106 to transmit transmission 114 in communication channel 112-1 during time window 113-1. In step 345, transceiver 106 may transmit transmission 114 in communication channel 112-1 during time window 113-1. If the listening result is indicative of communication channel 112-1 being busy, in step 350, control circuit 110 may direct transceiver 106 to transmit a signal different from transmission 114 (e.g., an empty packet) in communication channel 112-1 during time window 113-1. In step 355, transceiver may transmit an empty packet in communication channel 112-1 during time window 113-1.

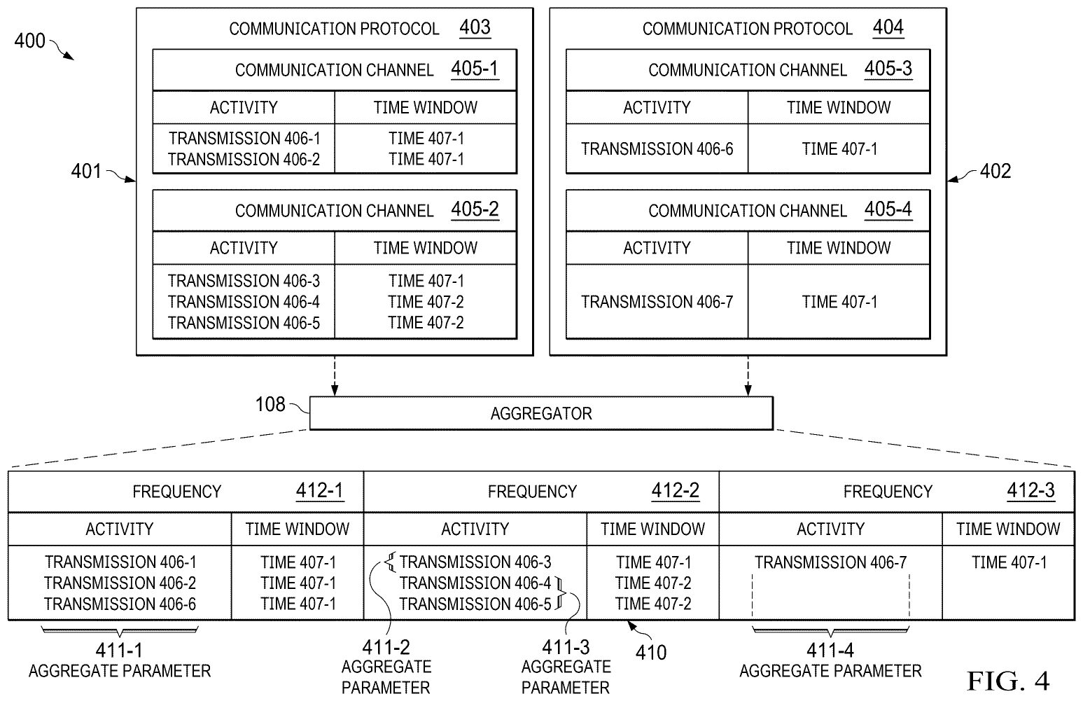

FIG. 4 shows an aspect of aggregating transmissions of a system, according to an embodiment of the present disclosure. FIG. 4 shows operating environment 400, which includes aggregator 108.

Aggregator 108 may be representative of one or more devices or circuits capable of identifying upcoming transmissions of device 105 among various communication protocols (e.g., communication protocol 403, communication protocol 404) and communication channel frequencies (e.g., communication channels 405) within the communication channels, protocols, or stacks thereof. Further, aggregator 108 may be configured to determine parameters of all the transmissions, scheduled, to be scheduled, and previously transmitted, of each communication channel frequency during time windows. To do so, aggregator 108 may be configured to receive transmission information 401 and 402 and determine transmission schedule 410, including aggregate parameters 411 of various transmissions 406.

Transmission information 401 and 402 may include information about a communication protocol, such as a name of the communication protocol, a list of transmissions within each frequency set of the communication protocol, the time window corresponding to each transmission, and the like. For example, in some embodiments, transmission information 401 may include transmissions 406-1, 406-2, 406-3, 406-4, and 406-5, which may be transmitted by transceiver 106 of device 105 in accordance with communication protocol 403. Similarly, transmission information 402 may include transmissions 406-6 and 406-7, which may be transmitted by transceiver 106 of device 105 in accordance with communication protocol 404.

In some embodiments, communication protocol 403 is a first communication protocol, such as one of Bluetooth, Bluetooth Low Energy (BLE), ZigBee, Wi-Fi, Long Term Evolution (LTE), or the like, and communication protocol 404 is a second communication protocol, such as one of the aforementioned protocols, that is different from the first communication protocol. For example, communication protocol 403 may be a Bluetooth protocol and communication protocol 404 may be a Wi-Fi protocol. Each of communication protocols 403 and 404 may include one or more communication channels corresponding to a frequency range with which a transceiver (e.g., transceiver 106) can transmit signals to other devices (e.g., device 120, device 125).

In some embodiments, communication protocol 403 includes communication channel 405-1 and communication channel 405-2, and communication protocol 404 includes communication channel 405-3 and communication channel 405-4. In some embodiments, with respect to communication protocol 403, communication channel 405-1 includes a first frequency (frequency 412-1), and communication channel 405-2 includes a second frequency (frequency 412-2). With respect to communication protocol 404, communication channel 405-3 includes the first frequency (frequency 412-1), and communication channel 405-4 includes a third frequency (frequency 412-3). In some such embodiments, while communication channels 405-1 and 405-3 include the first frequency, it may be appreciated that the frequency ranges included in communication channel 405-1 of communication protocol 403 might not be the same frequency ranges included in communication channel 405-3 of communication protocol 404, but the frequency ranges may be similar (e.g., two substantially overlapping frequency ranges). Additionally, in some embodiments, the frequencies of each of communication channels 405-1, 405-2, 405-3, and 405-4 may each be associated with a threshold parameter level. In some embodiments, each communication channel (e.g., 405-1, 405-2, 405-3, 405-4) may be associated with a respective single threshold parameter level, which may be based on the bandwidth of the associated communication channel.

In some embodiments, the transceiver may be configured to transmit transmissions 406-1 and 406-2 using communication channel 405-1 of communication protocol 403 during time 407-1. The transceiver may further be configured to transmit transmission 406-3 using communication channel 405-2 of communication protocol 403 during time 407-1 and transmissions 406-4 and 406-5 using communication channel 405-2 of communication protocol 403 during time 407-2. The transceiver may also be configured to transmit transmission 406-6 using communication channel 405-3 of communication protocol 404 during time 407-1 and transmission 406-7 using communication channel 405-4 of communication protocol 404 during time 407-1.

In various embodiments, aggregator 108 may be configured to identify an upcoming transmission among the transmissions included in transmission information 401 and 402 and determine aggregate parameters for all transmissions in each of communication channels 405-1, 405-2, 405-3, and 405-4 during respective time windows. In doing so, aggregator 108 may determine transmission schedule 410. It follows that transmission schedule 410 includes information about transmissions 406, such as a corresponding time window, a corresponding aggregate parameter, and a corresponding communication channel.

As illustrated in operating environment 400, aggregator 108 may be configured to determine that transceiver 106 is scheduled to transmit transmissions 406-1, 406-2, and 406-6 using frequency 412-1 during time 407-1. Aggregator 108 may be configured to determine parameters for each of transmissions 406-1, 406-2, and 406-6 and generate aggregate parameter 411-1 including the total parameters for such transmissions within frequency 412-1 during time 407-1. Similarly, aggregator 108 may be configured to determine that transceiver 106 is scheduled to transmit transmissions 406-3, 406-4, and 406-5 using frequency 412-2 during times 407-1 and 407-2. Aggregator 108 may be configured to generate aggregate parameter 411-2 corresponding to frequency 412-2 during time 407-1 and aggregate parameter 411-3 corresponding to frequency 412-2 during time 407-2. Aggregator 108 may further be configured to determine that transceiver 106 is scheduled to transmit transmission 406-7 using frequency 412-3 during time 407-1. As such, aggregator 108 may be configured to generate aggregate parameter 411-4 corresponding to frequency 412-3 during time 407-1.

Based on transmission schedule 410 and corresponding aggregate parameters 411, aggregator 108 may be configured to direct transceiver 106 to transmit specific transmissions using certain communication channels or during a certain time window. For example, aggregator 108 may perform a comparison between an aggregate parameter and a threshold parameter level to determine whether to direct transceiver 106 to transmit a transmission within a communication channel during a time window, as described above with respect to FIGS. 1A and 1B, FIGS. 2A and 2B, and FIG. 3.

In some embodiments, fewer or additional communication protocols may be included, and each communication protocol may include fewer or additional communication channels and/or protocol stacks with which a transceiver may transmit signals. It follows that aggregator 108 may be configured to identify aggregate parameters for various numbers of transmissions across communication protocols, channels, and stacks for use in transmitting, delaying, or re-configuring transmissions to avoid performing listening operations prior to transmitting the transmissions.

Example embodiments of the present disclosure are summarized here. Other embodiments can also be understood from the entirety of the specification and the claims filed herein.

Example 1. A method, including: determining a first upcoming transmission from a device in a first communication channel during a first time window; determining a first aggregate parameter associated with transmissions of the device in the first communication channel during the first time window; and in response to determining that the first aggregate parameter does not exceed the threshold parameter level, transmitting the first upcoming transmission in the first communication channel during the first time window without listening to the first communication channel.

Example 2. The method of example 1, further including: determining a second upcoming transmission in the first communication channel during a second time window; determining a second aggregate parameter associated with transmissions of the device in the first communication channel during the second time window; and in response to determining that the second aggregate parameter does not exceed the threshold parameter level, transmitting the second upcoming transmission in the first communication channel during the second time window without listening to the first communication channel, wherein the second time window occurs after the first time window.

Example 3. The method of one of examples 1 or 2, wherein the second time window partially overlaps with the first time window.

Example 4. The method of one of examples 1 to 3, wherein the first time window and the second time window have the same duration.

Example 5. The method of one of examples 1 to 4, wherein the first aggregate parameter comprises: a number of transmissions from the device, a size of the upcoming transmission, a duration of the upcoming transmission, or a power of the upcoming transmission.

Example 6. The method of one of examples 1 to 5, further comprising, in response to determining that the first aggregate parameter exceeds the threshold parameter level, transmitting the first upcoming transmission in a second communication channel during the first time window without listening to the second communication channel.

Example 7. The method of one of examples 1 to 6, further comprising determining a second aggregate parameter associated with transmissions of the device in the second communication channel during the first time window, wherein transmitting the first upcoming transmission in the second communication channel during the first time window without listening to the second communication channel comprises transmitting the first upcoming transmission in response to the second aggregate parameter being below the threshold parameter level.

Example 8. The method of one of examples 1 to 7, wherein transmitting the first upcoming transmission in the second communication channel during the first time window without listening to the second communication channel comprises transmitting the first upcoming transmission using a Multi-Link Operation.

Example 9. The method of one of examples 1 to 8, wherein the Multi-Link Operation is in accordance with a Wi-Fi communication protocol.

Example 10. The method of one of examples 1 to 9, wherein the Multi-Link Operation is in accordance with an LTE communication protocol.

Example 11. The method of one of examples 1 to 10, further comprising, in response to determining that the first aggregate parameter exceeds the threshold parameter level: determining a different aggregate parameter with which to configure to the first upcoming transmission during the first time window; configuring the first upcoming transmission with the different aggregate parameter; and transmitting the first upcoming transmission in the first communication channel during the first time window without listening to the first communication channel.

Example 12. The method of one of examples 1 to 11, further comprising, in response to determining that the first aggregate parameter exceeds the threshold parameter level, transmitting the first upcoming transmission in a second time window in the first communication channel without listening to the first communication channel, wherein the second time window occurs after the first time window.

Example 13. The method of one of examples 1 to 12, further comprising, in response to determining that the first aggregate parameter exceeds the threshold parameter level: listening to the first communication channel during the first time window to generate a first listening result; and transmitting the first upcoming transmission in the first communication channel based on the first listening result.

Example 14. The method of one of examples 1 to 13, wherein transmitting the first upcoming transmission based on the first listening result comprises transmitting the first upcoming transmission during the first time window in the first communication channel when the first listening result is indicative of the first communication channel not being busy.

Example 15. The method of one of examples 1 to 14, wherein a duration of the listening to the first communication channel during the first time window is based on the first upcoming transmission.

Example 16. The method of one of examples 1 to 15, further comprising determining a first re-transmission rate associated with the first upcoming transmission, wherein the duration of the listening to the first communication channel is based on the first retransmission rate.

Example 17. The method of one of examples 1 to 16, wherein the duration of the listening to the first communication channel is based on a bit error rate (BER) associated with the first communication channel.

Example 18. The method of one of examples 1 to 17, wherein listening to the first communication channel comprises performing a detect-and-avoid operation.

Example 19. The method of one of examples 1 to 18, wherein listening to the first communication channel comprises performing a detect-and-avoid operation.

Example 20. The method of one of examples 1 to 19, further comprising transmitting an empty packet during the first time window in the first communication channel in response to the first listening result being indicative of the first communication channel being busy.

Example 21. The method of one of examples 1 to 20, wherein the first upcoming transmission is associated with a first communication protocol, the method further comprising, in response to determining that the first aggregate parameter exceeds the threshold parameter level, adjusting a list of channels of a frequency hopping sequence associated with the first communication protocol.

Example 22. The method of one of examples 1 to 21, wherein the first communication protocol is a Bluetooth or Bluetooth Low Energy (BLE) protocol.

Example 23. The method of one of examples 1 to 22, wherein the first upcoming transmission is associated with a first communication protocol, and wherein the first aggregate parameter is based on transmissions of the device according to the first communication protocol and a second communication protocol.

Example 24. The method of one of examples 1 to 23, wherein the first upcoming transmission is associated with a first protocol stack, and wherein the first aggregate parameter is based on transmissions of the device according to the first protocol stack and a second protocol stack.

Example 25. The method of one of examples 1 to 24, wherein the first protocol stack corresponds to a first communication protocol and the second protocol stack corresponds to the first communication protocol.

Example 26. The method of one of examples 1 to 25, wherein the first upcoming transmission is associated with a first communication protocol, and wherein the device periodically performs transmissions in accordance with the first communication protocol every first time, the method further comprising, in response to determining that the first aggregate parameter exceeds the threshold parameter level, modifying the first time.

Example 27. The method of one of examples 1 to 26, wherein the threshold parameter level is based on a government-regulated allowed utilization amount.

Example 28. A device, including: a transmitter circuit; and a processor coupled to the transmitter circuit and configured to: determine a first upcoming transmission from the device in a first communication channel during a first time window; determine a first aggregate parameter associated with transmissions of the device in the first communication channel during the first time window; and in response to determining that the first aggregate parameter does not exceed the threshold parameter level, transmit, via the transmitter circuit, the first upcoming transmission in the first communication channel during the first time window without listening to the first communication channel.

Example 29. The device of example 28, wherein the processor is further configured to: determine a second upcoming transmission in the first communication channel during a second time window; determine a second aggregate parameter associated with transmissions of the device in the first communication channel during the second time window; and in response to determining that the second aggregate parameter does not exceed the threshold parameter level, transmit, via the transmitter circuit, the second upcoming transmission in the first communication channel during the second time window without listening to the first communication channel, wherein the second time window occurs after the first time window.

Example 30. The device of example 28 or 29, wherein the second time window partially overlaps with the first time window.

Example 31. The device of one of examples 28 to 30, wherein the first time window and the second time window have the same duration.

Example 32. The device of one of examples 28 to 31, wherein the first aggregate parameter comprises: a number of transmissions from the device, a size of the upcoming transmission, a duration of the upcoming transmission, or a power of the upcoming transmission.

Example 33. The device of one of examples 28 to 32, wherein the processor is further configured to, in response to determining that the first aggregate parameter exceeds the threshold parameter level, transmit, via the transmitter circuit, the first upcoming transmission in a second communication channel during the first time window without listening to the second communication channel.

Example 34. The device of one of examples 28 to 33, wherein the processor is further configured to determine a second aggregate parameter associated with transmissions of the device in the second communication channel during the first time window, wherein to transmit the first upcoming transmission in the second communication during the first time window without listening to the second communication channel, the processor is configured to transmit, via the transmitter circuit, the first upcoming transmission in response to the second aggregate parameter being below the threshold parameter level.

Example 35. The device of one of examples 28 to 34, wherein to transmit the first upcoming transmission in the second communication channel during the first time window without listening to the second communication channel, the processor is configured to transmit the first upcoming transmission using a Multi-Link Operation in accordance with one of a Wi-Fi protocol and an LTE communication protocol.

Example 36. The device of one of examples 28 to 35, wherein to transmit the first upcoming transmission in the second communication channel during the first time window without listening to the second communication channel, the processor is configured to transmit the first upcoming transmission using a Multi-Link Operation in accordance with an LTE communication protocol.

Example 37. The device of one of examples 28 to 36, wherein the processor is further configured to, in response to determining that the first aggregate parameter exceeds the threshold parameter level, transmit, via the transmitter circuit, the first upcoming transmission in a second time window in the first communication channel without listening to the first communication channel, wherein the second time window occurs after the first time window.

Example 38. The device of one of examples 28 to 37, wherein the processor is further configured to, in response to determining that the first aggregate parameter exceeds the threshold parameter level: listen to the first communication channel during the first time window to generate a first listening result; and transmit, via the transmitter circuit the first upcoming transmission in the first communication channel based on the first listening result.

Example 39. The device of one of examples 28 to 38, wherein to transmit the first upcoming transmission based on the first listening result, the processor is configured to transmit, via the transmitter circuit, the first upcoming transmission during the first time window in the first communication channel when the first listening result is indicative of the first communication channel not being busy.

Example 40. The device of one of examples 28 to 39, wherein a duration of the listening to the first communication channel during the first time window is based on the first upcoming transmission.

Example 41. The device of one of examples 28 to 40, wherein the processor is further configured to determine a first re-transmission rate associated with the first upcoming transmission, wherein the duration of the listening to the first communication channel is based on the first retransmission rate.

Example 42. The device of one of examples 28 to 41, wherein to listen to the first communication channel, the processor is configured to perform a listen-before-talk operation.

Example 43. The device of one of examples 28 to 42, wherein to listen to the first communication channel, the processor is configured to perform a detect-and-avoid operation.

Example 44. The device of one of examples 28 to 43, wherein the processor is further configured to transmit, via the transmitter circuit, an empty packet during the first time window in the first communication channel in response to the first listening result being indicative of the first communication channel being busy.

Example 45. The device of one of examples 28 to 44, wherein the first upcoming transmission is associated with a first communication protocol, and wherein the processor is further configured to, in response to determining that the first aggregate parameter exceeds the threshold parameter level, adjust a list of channels of a frequency hopping sequence associated with the first communication protocol.

Example 46. The device of one of examples 28 to 45, wherein the first communication protocol is a Bluetooth or Bluetooth Low Energy (BLE) protocol.

Example 47. The device of one of examples 28 to 46, wherein the threshold parameter level is based on a government-regulated allowed utilization amount.

Example 48. A device, including: a transmitter circuit; a communication channel monitoring circuit; and a transmission control circuit; wherein the communication channel monitoring circuit is configured to: determine a first upcoming transmission from a device in a first communication channel during a first time window; determine a first aggregate parameter associated with transmissions of the device in the first communication channel during the first time window; and perform a comparison between the first aggregate parameter and the threshold parameter level and provide a result of the comparison to the transmission control circuit; and wherein the transmission control circuit is configured to, in response to the result being indicative that the first aggregate parameter does not exceed the threshold parameter level, transmit, via the transmitter circuit, the first upcoming transmission in the first communication channel during the first time window without listening to the first communication channel.

Example 49. The device of example 50, wherein: the communication channel monitoring circuit is further configured to: determine a second upcoming transmission in the first communication channel during a second time window; and determine a second aggregate parameter associated with transmissions of the device in the first communication channel during the second time window; and perform a second comparison between the second aggregate parameter and the threshold parameter level and provide a second result of the second comparison to the transmission control circuit; and the transmission control circuit is further configured to, in response to the second result being indicative that the second aggregate parameter does not exceed the threshold parameter level, transmit, via the transmitter circuit, the second upcoming transmission in the first communication channel during the second time window without listening to the first communication channel, wherein the second time window occurs after the first time window.

Example 50. The device of example 48 or 49, wherein the second time window partially overlaps with the first time window.

Example 51. The device of one of examples 48 to 50, wherein the first time window and the second time window have the same duration.

Example 52. The device of one of examples 48 to 51, wherein the first aggregate parameter comprises: a number of transmissions from the device, a size of the upcoming transmission, a duration of the upcoming transmission, or a power of the upcoming transmission.

Example 53. The device of one of examples 48 to 52, wherein the transmission control circuit is further configured to, in response to the result being indicative that the first aggregate parameter exceeds the threshold parameter level, transmit, via the transmitter circuit, the first upcoming transmission in a second communication channel during the first time window without listening to the second communication channel.

Example 54. The device of one of examples 48 to 53, wherein the communication channel monitoring circuit is further configured to determine a second aggregate parameter associated with transmissions of the device in the second communication channel during the first time window, wherein to transmit the first upcoming transmission in the second communication during the first time window without listening to the second communication channel, the transmission control circuit is configured to transmit, via the transmitter circuit, the first upcoming transmission in response to the second result being indicative that the second aggregate parameter falls below the threshold parameter level.

Example 55. The device of one of examples 48 to 54, wherein the transmission control circuit is further configured to, in response to the result being indicative that the first aggregate parameter exceeds the threshold parameter level, transmit, via the transmitter circuit, the first upcoming transmission in a second time window in the first communication channel without listening to the first communication channel, wherein the second time window occurs after the first time window.

Example 56. The device of one of examples 48 to 55, wherein: the communication channel monitoring circuit is further configured to: in response to the result being indicative that the first aggregate parameter exceeds the threshold parameter level, listen to the first communication channel during the first time window to generate a first listening result; and provide the first listening result to the transmission control circuit; and the transmission control circuit is further configured to transmit, via the transmitter circuit the first upcoming transmission in the first communication channel based on the first listening result.

Example 57. The device of one of examples 48 to 56, wherein to transmit the first upcoming transmission based on the first listening result, the transmission control circuit is configured to transmit, via the transmitter circuit, the first upcoming transmission during the first time window in the first communication channel when the first listening result is indicative of the first communication channel not being busy.

Example 58. The device of one of examples 48 to 57, wherein a duration of the listening to the first communication channel during the first time window is based on the first upcoming transmission.

Example 59. The device of one of examples 48 to 58, wherein to listen to the first communication channel, the communication channel monitoring circuit is configured to perform a listen-before-talk operation.

Example 60. The device of one of examples 48 to 59, wherein to listen to the first communication channel, the communication channel monitoring circuit is configured to perform a detect-and-avoid operation.

Example 61. The device of one of examples 48 to 60, wherein the transmission control circuit is further configured to transmit, via the transmitter circuit, an empty packet during the first time window in the first communication channel in response to the first listening result being indicative of the first communication channel being busy.

Example 62. The device of one of examples 48 to 61, wherein the threshold parameter level is based on a government-regulated allowed utilization amount.

Example 63. A method, including: determining a first upcoming transmission from a device in a first communication channel during a first time window; determining a first aggregate parameter associated with transmissions of the device in the first communication channel during the first time window; in response to determining that the first aggregate parameter does not exceed the threshold parameter level, transmitting the first upcoming transmission in the first communication channel during the first time window without listening to the first communication channel; and in response to determining that the first aggregate parameter exceeds the threshold parameter level: listening to the first communication channel during the first time window to generate a first listening result; and transmitting the first upcoming transmission in the first communication channel based on the first listening result.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. A method comprising:
determining a first upcoming transmission from a device in a first communication channel during a first time window;
determining a first aggregate parameter associated with transmissions of the device in the first communication channel during the first time window; and
in response to determining that the first aggregate parameter does not exceed the threshold parameter level, transmitting the first upcoming transmission in the first communication channel during the first time window without listening to the first communication channel.

2. The method of claim 1, further comprising:
determining a second upcoming transmission in the first communication channel during a second time window;
determining a second aggregate parameter associated with transmissions of the device in the first communication channel during the second time window; and
in response to determining that the second aggregate parameter does not exceed the threshold parameter level, transmitting the second upcoming transmission in the first communication channel during the second time window without listening to the first communication channel, wherein the second time window occurs after the first time window.

3. The method of claim 2, wherein the second time window partially overlaps with the first time window.

4. The method of claim 2, wherein the first time window and the second time window have the same duration.

5. The method of claim 1, wherein the first aggregate parameter comprises: a number of transmissions from the device, a size of the upcoming transmission, a duration of the upcoming transmission, or a power of the upcoming transmission.

6. The method of claim 1, further comprising, in response to determining that the first aggregate parameter exceeds the threshold parameter level, transmitting the first upcoming transmission in a second communication channel during the first time window without listening to the second communication channel.

7. The method of claim 6, further comprising determining a second aggregate parameter associated with transmissions of the device in the second communication channel during the first time window, wherein transmitting the first upcoming transmission in the second communication channel during the first time window without listening to the second communication channel comprises transmitting the first upcoming transmission in response to the second aggregate parameter being below the threshold parameter level.

8. The method of claim 6, wherein transmitting the first upcoming transmission in the second communication channel during the first time window without listening to the second communication channel comprises transmitting the first upcoming transmission using a Multi-Link Operation.

9. The method of claim 8, wherein the Multi-Link Operation is in accordance with a Wi-Fi communication protocol.

10. The method of claim 8, wherein the Multi-Link Operation is in accordance with an LTE communication protocol.

11. The method of claim 1, further comprising, in response to determining that the first aggregate parameter exceeds the first communication channel's threshold parameter level:
determining a different aggregate parameter with which to configure to the first upcoming transmission during the first time window;
configuring the first upcoming transmission with the different aggregate parameter; and
transmitting the first upcoming transmission in the first communication channel during the first time window without listening to the first communication channel.

12. The method of claim 1, further comprising, in response to determining that the first aggregate parameter exceeds the threshold parameter level, transmitting the first upcoming transmission in a second time window in the first communication channel without listening to the first communication channel, wherein the second time window occurs after the first time window.

13. The method of claim 1, further comprising, in response to determining that the first aggregate parameter exceeds the threshold parameter level:
listening to the first communication channel during the first time window to generate a first listening result; and
transmitting the first upcoming transmission in the first communication channel based on the first listening result.

14. The method of claim 13, wherein transmitting the first upcoming transmission based on the first listening result comprises transmitting the first upcoming transmission during the first time window in the first communication channel when the first listening result is indicative of the first communication channel not being busy.

15. The method of claim 13, wherein a duration of the listening to the first communication channel during the first time window is based on the first upcoming transmission.

16. The method of claim 15, further comprising determining a first re-transmission rate associated with the first upcoming transmission, wherein the duration of the listening to the first communication channel is based on the first retransmission rate.

17. The method of claim 15, wherein the duration of the listening to the first communication channel is based on a bit error rate (BER) associated with the first communication channel.

18. The method of claim 13, wherein listening to the first communication channel comprises performing a detect-and-avoid operation.

19. The method of claim 13, wherein listening to the first communication channel comprises performing a detect-and-avoid operation.

20. The method of claim 13, further comprising transmitting an empty packet during the first time window in the first communication channel in response to the first listening result being indicative of the first communication channel being busy.

21. The method of claim 1, wherein the first upcoming transmission is associated with a first communication protocol, the method further comprising, in response to determining that the first aggregate parameter exceeds the threshold parameter level, adjusting a list of channels of a frequency hopping sequence associated with the first communication protocol.

22. The method of claim 21, wherein the first communication protocol is a Bluetooth or Bluetooth Low Energy (BLE) protocol.

23. The method of claim 1, wherein the first upcoming transmission is associated with a first communication protocol, and wherein the first aggregate parameter is based on first parameters of transmissions of the device according to the first communication protocol and second parameters of transmissions of the device according to a second communication protocol.

24. The method of claim 1, wherein the first upcoming transmission is associated with a first protocol stack, and wherein the first aggregate parameter is based on first parameters of transmissions of the device according to the first protocol stack and second parameters of transmissions of the device according to a second protocol stack.

25. The method of claim 24, wherein the first protocol stack corresponds to a first communication protocol and the second protocol stack corresponds to the first communication protocol.

26. The method of claim 1, wherein the first upcoming transmission is associated with a first communication protocol, and wherein the device periodically performs transmissions in accordance with the first communication protocol every first time, the method further comprising, in response to determining that the first aggregate parameter exceeds the threshold parameter level, modifying the first time.

27. The method of claim 1, wherein the threshold parameter level is based on a government-regulated allowed utilization amount.
